(19) United States
(12) Patent Application Publication
(10) Pub. No.: US 2004/0267493 A1
(43) Pub. Date: Dec. 30, 2004

(54) Method and system for measuring rotational speed of a motor vehicle wheels

(76) Inventors: Thierry Pinard, Garches (FR); Nicolas Michel, Sartrouville (FR); Francis Delaporte, Osny (FR); Serge Hernando, Cergy (FR)

Correspondence Address: FOLEY & LARDNER, 777 EAST WISCONSIN AVENUE, SUITE 3800, MILWAUKEE, WI, 53202-5308, US

(21) Appl. No.: 10/493,937

(22) PCT Filed: Oct. 30, 2002
(86) PCT No.: PCT/FR02/03744

(30) Foreign Application Priority Data
Oct. 31, 2001 (FR) 01/14140

(51) Int. Cl. G06F 15/00

(52) U.S. Cl. 702/145; 702/148

(57) ABSTRACT

A method for determining a rotational speed of a rotating object of a vehicle includes providing information unrelated to the rotational speed of the object of the vehicle using an electronic device and providing information related to the rotational speed of the object of the vehicle using the electronic device. One example of a system employing this method is a tire pressure sensor system. The tire pressure sensor provides information regarding the pressure of the tire of the vehicle. Likewise, a periodicity in a signal transmitted by a transmitter associated with the tire pressure sensor can be used to determine the rotational speed of the wheel of the vehicle to which the tire is attached.

### CROSS-REFERENCE TO RELATED PATENT APPLICATIONS

The present application is a U.S. national phase filing of PCT/FR02/03744 filed Oct. 30, 2002, which claims priority to French Application No. 01/14140 filed Oct. 31, 2001, the disclosures of which are hereby incorporated by reference.

### BACKGROUND

The present invention relates to the measurement of the rotational speed of the wheels of automobiles. These rotational speeds may be useful in particular in wheel anti-locking systems or travel control systems.

There are many methods available which permit the rotational speed of the wheels of automobiles to be measured, the most basic being the simple rev-counter. However, these methods always require specific devices which are therefore costly in terms of assembly and maintenance.

Wheel tire pressure sensors are also known. These tire pressure sensors are becoming more and more widely used, it could almost be said that manufacturers systematically mount them on their vehicles. FR 2 774 178 discloses that the signal emitted by the emitter of a wheel tire pressure sensor, rotationally driven with the wheel, is modulated in amplitude during rotation as a function of the obstacles and other fixed masking objects due to the portion of the chassis which is disposed between said emitter and the corresponding receiver.

### SUMMARY

The Applicant has also noticed that the modulation envelope of the signal from a tire pressure sensor was a periodic signal whose period is equal to the length of one revolution of the wheel.

To this end, the present invention relates to a method for measuring rotational speeds of the wheels of an automobile. In some embodiments, this is characterized by the fact that the envelopes of the signals from the emitters of the tire pressure sensors of said wheels are detected and their periods are determined so as to deduce therefrom their rotational speeds.

Of course, the angular rotational speed v, in revolutions/second, and linear rotational speed V, in meters/second, of a wheel having a circumference of length c and on the wheel nm of which the emitter of the sensor emits a signal modulated by the rotation in accordance with an envelope of period T, are given by the following formulae: v=1/T; V=c.v.

An important feature of the method of an exemplary embodiment is that no additional equipment is necessary, other than the tire pressure monitoring system.

Another embodiment also relates to a system for measuring the rotational speeds of the wheels of an automobile for implementation of the method, comprising a set of wheel tire pressure sensors having emitters mounted on the wheels, means for processing the signal in order to extract the modulation envelopes from the signals emitted by the emitters, to calculate the period of these envelopes, and to deduce therefrom the rotational speeds.

The measuring system in accordance with some embodiments may also comprise means for estimating the period of the modulation envelopes before measuring said period, for example means indicating the linear speed of the vehicle.

Owing thereto, it is possible to measure the rotational speeds only during a minimum time taking into account the speed of the vehicle.

### BRIEF DESCRIPTION OF THE DRAWINGS

FIG. 1 shows the block diagram of the system according to an exemplary embodiment;

FIG. 2 shows a typical signal output by a pressure sensor and its modulation envelope;

FIG. 3 shows the flow chart of the method for determining the rotational speed of a wheel; and

FIG. 4 shows how the method is implemented on the four wheels of a vehicle.

The system for measuring the rotational speed of a wheel 11 in accordance with one embodiment will now be described.

### DETAILED DESCRIPTION

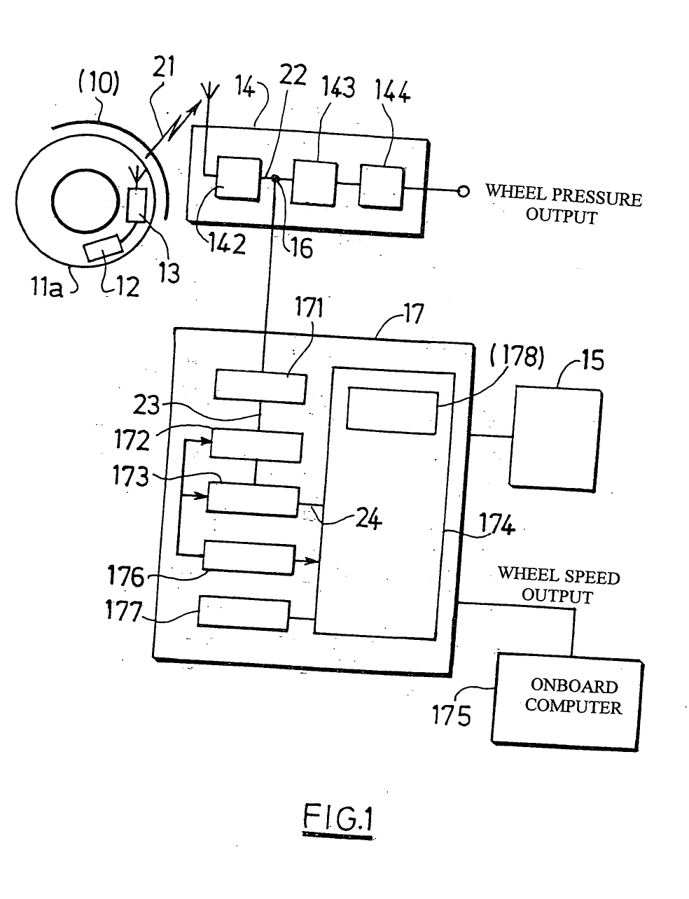

With reference to FIG. 1, the embodiment comprises an assembly having a pressure sensor 12 and its emitter 13 both mounted on the wheel 11 as well as a fixed receiver 14 intended to process the signal 21 emitted by the emitter 13.

Generally, the fixed receiver 14 comprises, in series, a receiving antenna 141, a demodulator 142 outputting an analogue carrier-free signal 22, a filter 143 and electronics 144 for processing the tire pressure data.

These devices permit the radio signals to be transformed into digital signals and the tire pressure to be calculated.

The system has, in this case downstream of the demodulator 142, a branching 16 of the signal received by the fixed receiver, supplying means 17 for processing the signal in order to extract the modulation envelope from the signal and in order to calculate the rotational speed of the wheel.

In this case, the signal processing means comprise, in series, the following means:

filtering means 171 for extracting the modulation envelope 23 from the signal,

acquisition means 172, 173 for sampling and digitising said envelope 23,

a calculating processor 174, 178 for determining the period of this envelope.

The system also comprises at least one clock 176 connected to the acquisition means and to the processor which is itself connected to at least one memory 177 for storing the samples and to the vehicle speed indicator 15.

In this example, the system also uses the onboard speed indicator 15 of the vehicle. This could equally be the odometer since it is disposed along the circumference of the wheels.

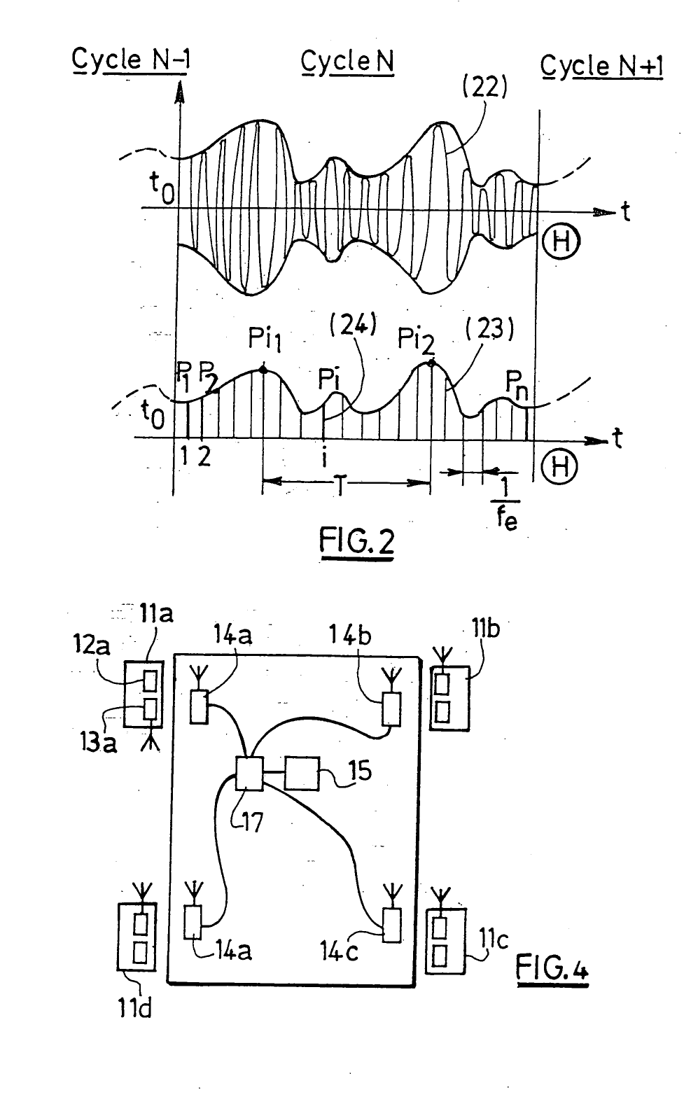

With reference to FIG. 2, the method consists of cyclically processing the signal emitted by the emitter of the pressure sensor, the cycle comprising an observation time Θ during which the amplitude maxima Pᵢ₁, Pᵢ₂, which are substantially equal and successive, and the times separating these maxima are detected.

These times correspond to the sought period T, from which the rotational speed will be deduced.

To obtain this result, the signal 22 is recovered at the output of the demodulator 142 and is submitted to low-pass filtering in the filter 143 so as to isolate the envelope.

This can be effected by an analogue filtering method, choosing a filter cutoff frequency, Fc, which is slightly greater than the maximum rotational frequency of the wheels.

The filtered signal is then sampled at a predetermined sampling frequency fe. In accordance with a well known signal processing rule, this frequency is at least double the cutoff frequency Fc.

The observation time Θ is determined from a piece of information regarding the speed of the vehicle, which information is available from other sources e.g. onboard instruments: speedometer, odometer.

In fact, if U is this speed in meters/second and c is the length in meters of the circumference of the wheel, the period T of rotation of the wheels is estimated by the ratio c/U. This estimation permits the observation time Θ be chosen such that it at least contains the two sought maxima:

$$Θ = \frac{2 c}{U}$$

The observation time Θ can, from a certain number of cycles, be optimized to a smaller value, taking into account the signal history, the knowledge of the speed of the vehicle and the position of the maximum in the period, up to a value close to, but always greater than, T such that the periodic signal, the period of which is to be determined, is completely located therein.

Once this difficulty has been removed, the n obtained sampled values P₁, P₂ . . . , Pᵢ, Pₙ are arranged into an order for example chronological 1, 2, . . . , i, . . . , n from a time to and during the thus determined observation time. Of course, the number n of arranged values is such that

n=fe.Θ

Two successive, substantially equal, maxima Pᵢ₁ and Pᵢ₂ are thus sought in the arranged signal, the values of the maxima correspond to the maximums of one and the other of two successive periods, and their arrangement locations i1 and 12 in this storing time Θ are noted.

The sought period is deduced therefrom.

T=(12−i1)/fe

And the rotational speed of the wheel between the time to and the time to +Θ is finally obtained using one of the above formulae.

The cycle which has just been described may be repeated in order to obtain successive rotational speeds. A sampling of the momentary rotational speed of the wheel is thus provided having a certain sampling frequency Fe.

Since a cycle contains at least one observation time to which, in theory, a processing time may be added, the length of the cycle may be longer and, in principle, may be fixed.

The method permits the rotational speed of the wheels to be measured in a continuous manner at a frequency

Fe=1/Θ

This frequency is variable and depends on the speed of the vehicle. The higher the speed, the higher the frequency. Thus a rotational speed of the wheel is obtained more quickly as the speed of the vehicle increases.

Returning to the embodiment of FIG. 1, the signal 21 emitted by the emitter 13 is subjected to a parasitic modulation in particular owing to the chassis 10 before being received by the receiver 14 and being processed therein so as to provide the pressure of the tires. Thus the signal 22 at the output of the demodulator 142 is filtered by the filter of the receiver 143 for the normal requirements for processing the pressure information.

The signal 22 is also filtered by the filter 171 of the signal processing means 17, for example an RC filter.

At the output of the filter 171, the signal 23 is constantly sampled and digitised at the frequency fe by a sample-and-hold device 172 which maintains the analogue magnitudes at regular times at the frequency fe and an analog to digital converter 173 which provides at its output 24 digital samples Pi of the signal for which the period is to be determined. These means effect these operations in particular owing to the clock 176, under the control of the processor 174.

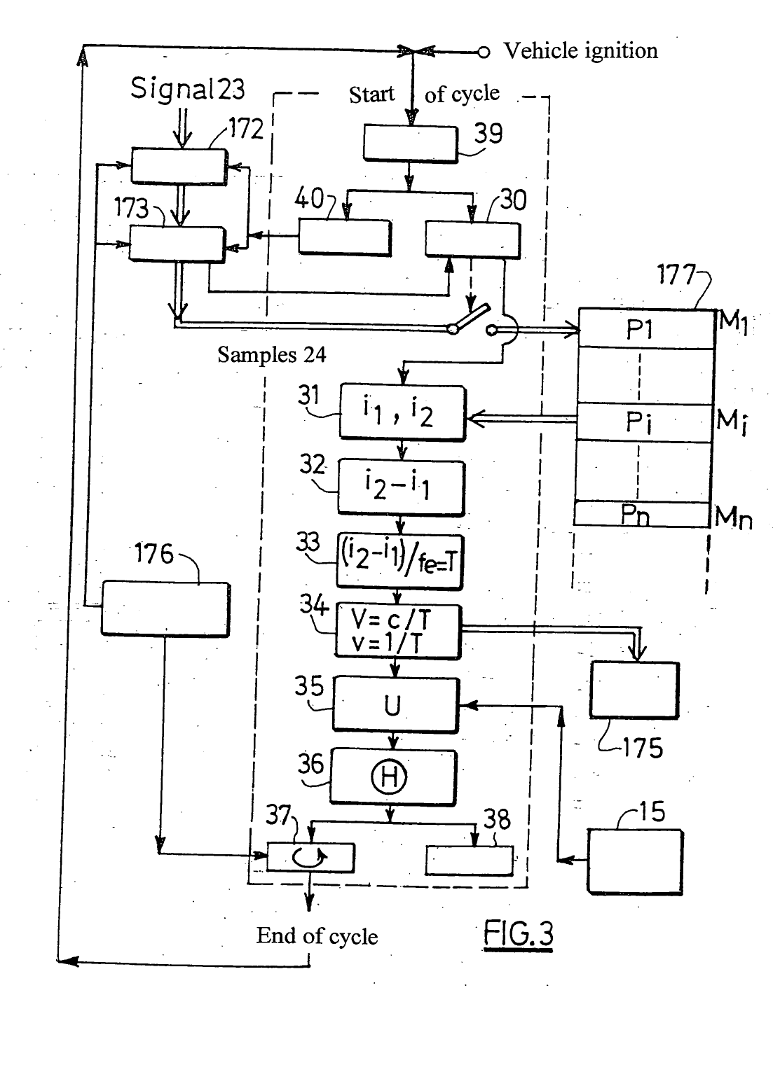

With reference to FIG. 3, the processor 174 transmits the control to the program of the memory 178 which acquires and arranges (30) these samples Pi in the memory 177 from P₁ to Pₙ from memory M₁ to memory Mₙ respectively.

Then the program, or the method, calculates the rotational speed of the wheel which it transmits to the onboard computer 175. To achieve this, at this stage, it effects the following steps successively:

searching (31) for the arrangement addresses i1 and i2 of the two largest values Pi in the memory 177,

calculating (32, 33) the time which separate these two rows i.e. the modulation envelope period T=(i2−i1)/fe,

calculating (34) the linear, V=c/T, or angular, v=1/T, rotational speeds and putting these speeds at the disposal of the user means 175,

acquiring (35) the speed of the vehicle U,

calculating (36) a new observation time Θ=2c/U and a new number of samples to be acquired n, in relation to the speed of the vehicle,

initializing (38) the following cycle consisting of updating the previously calculated time Θ and number n, and of clearing the memory 177,

waiting (37), if necessary, for start of the following cycle to +(N+1)Θ,

starting the next cycle (39) and then controlling (40) the sample-and-hold device and the converter 172, 173.

It is not necessary to wait for the end of the current cycle if the calculations are to end at the same time as the current cycle ends. This is the case when the steps of observing and acquiring the samples and the steps of calculating the speeds are consecutive.

This is not the case for a more complex version wherein the steps of determining the rotational speed of a wheel effected during the cycle N correspond to samples observed and acquired during cycle N−1.

For this more complex version, the calculation of the speed at cycle N corresponds, in fact, to the observation of the signal at cycle N−1. Thus during the time from to +N.Θ to +(N+1).Θ the microprocessor, after acquiring the n samples, calculates the rotational speed at which the wheel was running during the time interval [to +(N−1).Θ, to +N.Θ)].

In the most common example of a measuring system for the set of wheels of a vehicle (FIG. 4) and thus comprising a set of wheel tire pressure sensors, the signal processing means (17) are common for the processing of the four wheels.

In the case of a system for measuring the tire pressure comprising four receivers of the (14a) type, the low-pass filter only needs to be quadrupled and the inputs to the sample-and-hold device and the A/D converter only need to be multiplexed for example. This reduces the amount of necessary equipment accordingly.

1. Method for measuring rotational speeds of wheels (11) of an automobile, comprising:
detecting envelopes of signals from emitters of tire pressure sensors; and
determining the periods of the envelopes so as to deduce therefrom their rotational speeds.

2. Method as claimed in claim 1, wherein the signal emitted by the emitter of the pressure sensor of a wheel is processed cyclically, said cycle comprising an observation time during which the signal is stored, the amplitude maximums, which are substantially equal and successive, are detected and the times separating these maximums are deduced therefrom.

3. Method as claimed in claim 1, wherein the signal emitted by the pressure sensor is recovered in order to subject it to a filtering or smoothing process so as to isolate the envelope from the signal.

4. Method as claimed in claim 2, wherein said observation time is determined from the speed of the vehicle.

5. Method as claimed in claim 2, wherein the length of the cycle is determined from the speed of the vehicle.

6. Measuring system for implementing a method for measuring rotational speeds of wheels of an automobile, comprising:
a set of wheel tire pressure sensors and of emitters mounted on the wheels, the emitters configured to emit signals,
means for processing the signals in order to extract modulation envelopes from the signals emitted by the emitters,
means for processing the signals to calculate the periods of the modulation envelopes, and
means for processing the signals to deduce the rotational speeds from the periods.

7. Measuring system as claimed in claim 6, wherein the means for processing the signals in order to extract modulation envelopes is mounted in a branched manner on means for receiving the signals from the emitters.

8. Measuring system as claimed in claims 6, wherein means are provided to estimate the period of the modulation envelopes comprising means (15) indicating a speed of the automobile.

9. A method for determining a rotational speed of a rotating object of a vehicle, comprising:
providing information unrelated to the rotational speed of the object of the vehicle using an electronic device;
providing information related to the rotational speed of the object of the vehicle using the electronic device.

10. The method of claim 9, wherein the electronic device is a wireless transmitter configured to transmit data.

11. The method of claim 10, wherein the transmitter is configured to transmit a radio frequency signal.

12. The method of claim 10, wherein the transmitter is coupled to a processing circuit such that the transmitter may transmit data acquired by the processing circuit.

13. The method of claim 12, further comprising acquiring tire pressure data using the processing circuit and transmitting the tire pressure data using the transmitter.

14. The method of claim 10, further comprising determining an observation time during which data from the transmitter is analyzed to determine the rotational speed of the object.

15. The method of claim 14, further comprising determining the observation time from a speed of the vehicle.

16. The method of claim 10, further comprising filtering or smoothing a signal from the transmitter.

17. The method of claim 16, further comprising isolating an envelope of the signal after it has been filtered or smoothed.

18. The method of claim 10, wherein the object is a wheel of the vehicle.

19. The method of claim 18, wherein the electronic device is a wireless transmitter configured to transmit data.

20. The method of claim 19, further comprising determining an observation time during which data from the transmitter is analyzed to determine the rotational speed of the object.

21. The method of claim 19, further comprising filtering or smoothing a signal from the transmitter.

22. The method of claim 21, further comprising isolating an envelope of the signal after it has been filtered or smoothed.

23. The method of claim 9, further comprising determining an observation time during which data from the transmitter is analyzed to determine the rotational speed of the object.

24. The method of claim 23, further comprising determining the observation time from a speed of the vehicle.

25. The method of claim 9, further comprising filtering or smoothing a signal from the transmitter.

26. The method of claim 25, further comprising isolating an envelope of the signal after it has been filtered or smoothed.

27. An automobile, comprising:
a sensor configured to obtain data relating to a parameter of the automobile, the parameter unrelated to a rotational speed of a wheel of the automobile;
a transmitter coupled to the sensor and configured to transmit data obtained by the sensor; and
a processing circuit configured to determine the rotational speed of the wheel of the automobile using data obtained from a signal transmitted the transmitter.

28. The automobile of claim 27, wherein the processing circuit is configured to use a periodicity in the signal transmitted by the transmitter to determine the rotational speed of the wheel of the automobile.

29. The automobile of claim 27, wherein the processing circuit is configured to obtain data to use to determine the rotational speed of the wheel of the automobile only during an observation period.

30. The automobile of claim 27, wherein the sensor comprises a pressure sensor.

31. The automobile of claim 30, wherein the parameter comprises pressure of a tire of the automobile.
